(19) United States
(12) Patent Application Publication
(10) Pub. No.: US 2012/0016698 A1
(43) Pub. Date: Jan. 19, 2012

(54) SYSTEMS AND METHODS FOR ALLOCATING INVENTORY

(75) Inventors: Andrew Gilmore, Oxfordshire (GB); Brian Smith, Milton, GA (US); Joe Kulbago, Grayson, GA (US); Jayesh Amdekar, Alpharetta, GA (US); Brian Denny, Atlanta, GA (US); Criss Chrestman, Buford, GA (US)

(73) Assignee: AGILYSYS NV, LLC, Alpharetta, GA (US)

(21) Appl. No.: 13/027,365

(22) Filed: Feb. 15, 2011

Related U.S. Application Data
(60) Provisional application No. 61/304,646, filed on Feb. 15, 2010.

(51) Int. Cl. G06Q 30/00

(52) U.S. Cl. 705/5; 705/314

(57) ABSTRACT

Computer-implemented systems and methods provide use an allocation process for allocating inventory items based on categories and attributes associated with the inventory items. The systems and methods allocate the inventory in accordance with a predefined hierarchy of the categories and attributes so as to effectively balance current reservations while accounting for overbook and/or retention criteria. The systems and methods facilitate the tracking of upgraded inventory reservations relative to non-upgraded inventory reservations. The inventory allocation can occur in real time and/or in accordance with a user-defined schedule. The inventory allocation can be substantially automated.

### RELATED APPLICATION

The present application is being filed as a U.S. non-provisional patent application claiming priority/benefit under 35 U.S.C. §119(e) from the U.S. provisional patent application having Ser. No. 61/304,646 and filed on Feb. 15, 2010, the entire disclosure of which is incorporated herein by reference.

### FIELD

The general inventive concepts relate to inventory management and, more particularly, to systems and methods for allocating inventory.

### BACKGROUND

Property management systems are computerized systems that facilitate the management of properties, often using a single software application. For example, in the hospitality industry, a property management system is a computerized system used to manage guest bookings, online reservations, point of sale, telephone and other amenities. Hotel property management systems may interface with central reservation systems, revenue or yield management systems, front office systems, back office systems, and point of sale systems.

In this manner, property management systems are useful for managing the property's inventory. For example, in the case of a hotel property, the property management system manages the hotel's rooms.

In the hospitality industry, rooms are classified based on a relatively limited set of categories. These categories include characteristics of, related to, or imposed on the room. For example, hotel rooms are often classified based on, and only on, the combination of the following three categories: (1) room quality, (2) bed size, and (3) smoking preference. Room quality is a somewhat arbitrary way of differentiating rooms, usually based on price. For example, the room quality category could be used to divide the inventory of rooms into standard rooms (S), deluxe rooms (D), and premium rooms (P). Bed size refers to the configuration of bedding in a room. For example, the bed size category could be used to divide the inventory of rooms into single twin bed (ST) rooms, double twin bed (DT) rooms, queen bed (SQ) rooms, and king bed (SK) rooms. Smoking preference indicates whether or not a room has been designated a smoking permissible room. Thus, the smoking preference category is used to divide the inventory of rooms into smoking-allowed (SA) rooms and non-smoking (NS) rooms.

Codes representing these categories are used to classify the inventory of rooms, with the codes being used by the property management system to manage the inventory of rooms. Based on the categories described above, each room is assigned one, and only one, of 24 codes derived from all possible combinations of the categories. For example, a deluxe room having a king-sized bed and in which smoking is allowed is assigned the code DSKSA, whereas a standard room having a single twin bed and in which smoking is prohibited is assigned the code SSTNS.

By their very nature, the codes involve multiple categories. These codes are hard-coded or otherwise input into the property management system in a manner in which they are not readily separable into their component categories.

Additionally, managing a hotel's rooms is a complex, dynamic process with reservations arriving in many different manners for many different dates. Also, some reservations are firm (e.g., deposited, guaranteed), while some reservations are tentative or at least tentative until actual check-in. Property management systems lack tools for assisting with and/or automating a process for allocating rooms based on any current state of reservations.

Personnel at the hotel must periodically (e.g., daily) take a look at the reservations for the inventory and attempt to “balance” the reservations, for example, among the aforementioned hard-coded categories. This is a tedious, labor intensive process that often involves an ad hoc, subjective, and/or arbitrary approach to determining which reservations to upgrade to a better room. Furthermore, the property management systems cannot readily track the upgraded reservations. Instead, it appears as if the person making the original reservation actually made the reservation for the upgraded room. Further still, because of the inflexibility presented by the relatively few hard-coded categories, the property management systems lack the ability to allocate rooms based on individual attributes and/or attribute combinations. These problems are exacerbated by the tendency of hotels to overbook (i.e., over sell) the rooms in an effort to achieve maximum capacity at all times.

### SUMMARY

The general inventive concepts contemplate computer-implemented systems and methods for allocating inventory in response to requests for a variety of inventory items comprising the inventory.

In one exemplary embodiment, computer-implemented systems and methods for allocating inventory items in a predefined, hierarchical fashion are disclosed. The systems and methods balance current reservations, while accounting for overbook and/or retention criteria.

In one exemplary embodiment, computer-implemented systems and methods for readily scheduling allocation of inventory items are disclosed, wherein the allocation of the inventory items is substantially automated.

In one exemplary embodiment, computer-implemented systems and methods for allocating inventory items are disclosed, wherein the systems and methods can readily track upgraded reservations for the inventory items relative to non-upgraded reservations for the inventory items.

In one exemplary embodiment, a computer-implemented system for attribute-based inventory management comprises: a computer; and a storage device storing data on a plurality of inventory items, wherein said data includes a plurality of attributes, wherein each of the inventory items is associated with one or more of the attributes, and wherein the system is operable to identify all of the inventory items corresponding to any one of the attributes.

In one exemplary embodiment, a computer-implemented method for attribute-based inventory management comprises: defining a plurality of attributes for a plurality of inventory items; associating at least one of the attributes with each of the inventory items; filtering the inventory items to determine which, if any, of the inventory items correspond to any one or more of the attributes, and determining a rate to be charged for any one of the inventory items based, at least in part, on its attributes.

In one exemplary embodiment, computer-implemented systems and methods for attribute-based inventory management are disclosed. The computer-implemented systems and methods include or otherwise use one or more computers for implementing attribute-based inventory management logic, which can be embodied as a series of circuits, programs, modules, functions, routines, steps, software, or the like. The attribute-based inventory management logic defines each inventory item by attributes of the inventory item. Thereafter, the inventory item can be managed, tracked, modified, marketed, sold, or otherwise processed based on any one or more of its attributes.

In one exemplary embodiment, computer-implemented systems and methods for attribute-based inventory management are disclosed. The systems and methods provide relational processing and views of inventory. In this manner, inventory having similar attributes can be identified, viewed and manipulated.

Accordingly, in one exemplary embodiment, computer-implemented systems and methods for allocating inventory items are disclosed, wherein the systems and methods can flexibly allocate the inventory items based on discrete attributes and related categories associated with the inventory items.

Numerous advantages and features attributable to the general inventive concepts will become readily apparent from the following detailed description of exemplary embodiments, from the claims and from the accompanying drawings.

### BRIEF DESCRIPTION OF THE DRAWINGS

For a fuller understanding of the nature and advantages of the general inventive concepts, reference should be had to the following detailed description taken in connection with the accompanying drawings, in which:

FIG. 1 is a diagram of a computer for use in a property management system and/or for implementing a property management method, according to one exemplary embodiment.

FIG. 2 is a diagram of a property management system, according to one exemplary embodiment.

FIG. 3 is a diagram of a property management system, according to one exemplary embodiment.

FIG. 4 shows a user interface for defining room attributes, according to one exemplary embodiment.

FIG. 5 shows a user interface for defining room attribute combinations, according to one exemplary embodiment.

FIG. 6 shows a user interface for assigning or otherwise associating room attributes with corresponding rooms, according to one exemplary embodiment.

FIG. 7 shows a user interface for assigning priorities among assigned room attributes and attribute combinations, according to one exemplary embodiment.

FIG. 8 shows a user interface for creating and/or modifying an overbook/retention pattern, according to one exemplary embodiment.

FIG. 9 shows a user interface for filtering inventory categories and attributes from use in an overbook/retention pattern, according to one exemplary embodiment.

FIG. 10 shows a user interface for initiating an allocation engine browser, according to one exemplary embodiment.

FIG. 11 shows an inventory availability calendar, according to one exemplary embodiment.

FIG. 12 is a flowchart illustrating operation of a method for scheduling and running a room (category) allocation process, according to one exemplary embodiment.

FIG. 13 is a flowchart illustrating operation of a method for modifying and running a room (category) allocation process, according to one exemplary embodiment.

FIG. 14 is a flowchart illustrating a room (category) allocation process, according to one exemplary embodiment.

### DESCRIPTION

While the general inventive concepts are susceptible of embodiment in many different forms, there are shown in the drawings and will be described herein in detail specific embodiments thereof with the understanding that the present disclosure is to be considered as an exemplification of the principles of the general inventive concepts. Accordingly, the general inventive concepts are not intended to be limited to the specific embodiments illustrated herein.

The following includes definitions of exemplary terms used throughout the disclosure. Both singular and plural forms of all terms fall within each meaning:

“Logic,” synonymous with “circuit” as used herein includes, but is not limited to, hardware, firmware, software and/or combinations of each to perform a function(s) or an action(s). For example, based on a desired application or needs, logic may include a software controlled microprocessor, discrete logic such as an application specific integrated circuit (ASIC), or other programmed logic device. Logic may also be fully embodied as software.

“Software,” as used herein, includes but is not limited to one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Computer” or “processing unit” as used herein includes, but is not limited to, any programmed or programmable electronic device that can store, retrieve, and process data.

In accordance with the general inventive concepts, disclosed herein are exemplary embodiments of property management systems and property management methods for effectively allocating inventory. Furthermore, the property management systems and methods can be adapted to allocate the inventory based on discrete attributes associated with the inventory items.

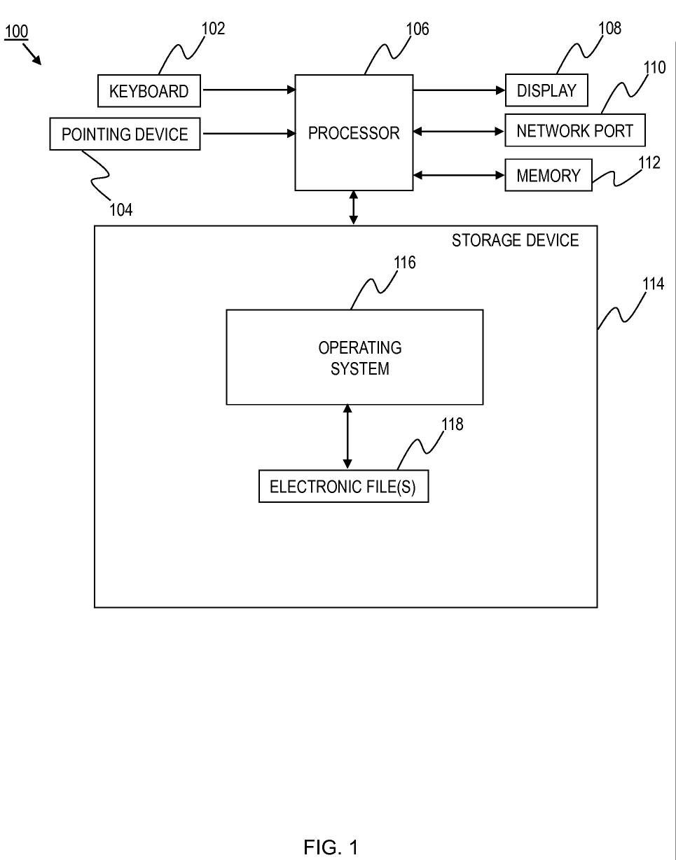

FIG. 1 shows a computer 100 (e.g., a general purpose desktop or laptop computer) for use in a property management system and/or a property management method, according to one exemplary embodiment. The computer 100 includes a processing means, such a CPU 106, and memory, such as RAM 112, for use by the processing means. The computer 100 also includes input means, such as a keyboard 102 and a mouse 104, and output means, such as a monitor 108. The monitor is, for example, an LCD or CRT display. The output means can include any device or mechanism for outputting signals generated by the computer 100. For example, the output means could include speakers (not shown) for outputting audio.

The computer includes a permanent and/or semi-permanent storage means, such as a hard disk drive 114. The hard disk drive 114 stores software applications, such as an operating system 116, and/or data in the form of electronic files 118. The computer 100 further includes a networking means, such as a network port or adapter 110. The network adapter 110 is, for example, an Ethernet adapter. The network adapter 110 allows the computer 100 to be connected to and communicate over a network, such as the Internet. The network adapter 110 supports, for example, wired or wireless communication over the network.

Various modifications could be made to the computer 100 without departing from the spirit and scope of the general inventive concepts. The computer 100 can be configured and used as a client and/or a server computer.

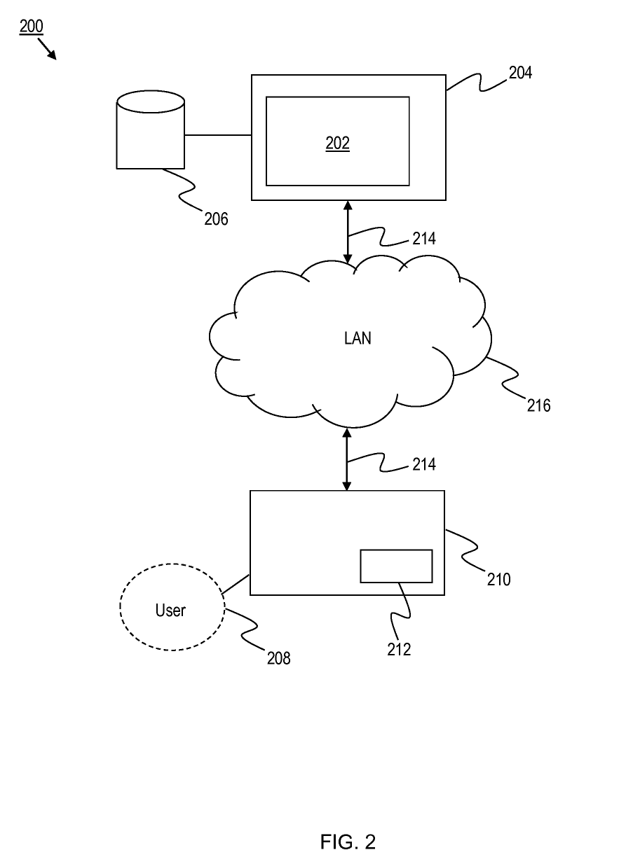

As shown in FIG. 2, a property management system 200, according to one exemplary embodiment, includes property management software 202 installed on a server computer 204 for managing inventory items of one or more properties. The server computer 204 utilizes a database 206 to store information (e.g., records) on the inventory items. The database 206 can be implemented, for example, on the hard disk drive 114 of the server computer 204 and/or across one or more discrete storage devices.

A user 208 of the property management system 200, such as a hotel booking agent, can use a client computer 210 to access the property management software 202 running on the server computer 204. In one exemplary embodiment, the system 200 authenticates the user 208 before granting access to the property management software 202. As one example, the system 200 may verify a username and a password input by the user 208.

The client computer 210 is used to display a user interface 212 generated by the server computer 204 to the user 208. By interacting with the user interface 212, the user 208 is able to effectively manage allocation of the inventory items, as described in more detail below.

In one exemplary embodiment, the server computer 204 is local to the client computer 210, with data communications 214 between the server computer 204 and the client computer 210 taking place over a local area network 216.

In one exemplary embodiment, the server computer 204 and the client computer 210 are integrated (e.g., into a single computer 100), with data communications occurring internally.

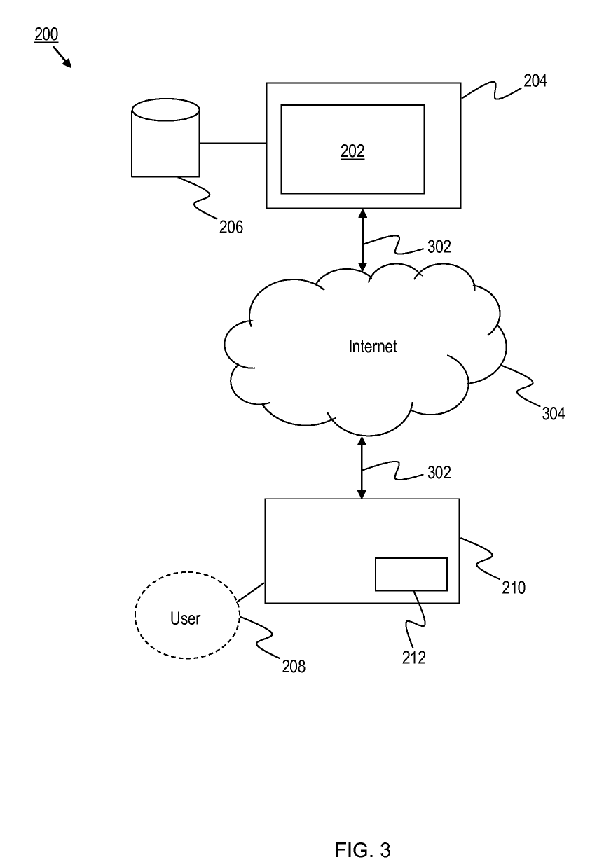

In one exemplary embodiment, shown in FIG. 3, the server computer 204 is remote from the client computer 210, with data communications 302 between the server computer 204 and the client computer 210 taking place over a wide area network or the Internet.

In one exemplary embodiment, the property management system 200 is a Web-based application, such that the client computer 210 can access the property management software 202 running on the server computer 204 using a standard Web browser (e.g., the Internet Explorer browser, Internet Explorer being a registered trademark of Microsoft Corporation) or similar application. In this manner, the property management system 200 does not require that any additional software is installed on the client computer 210.

The property management software 202 implements an allocation engine for effectively allocating items of the inventory (e.g., rooms) based on a current state of commitments (e.g., reservations) for the inventory items. Additionally, the property management software 202 supports an attribute-based view of the inventory, which can be utilized in allocating the inventory items.

As noted above, the property management software 202 generates a user interface 212 to promote interaction between the user 208 and the property management system 200, wherein the allocation engine allows the user to control the effective allocation of the rooms, for example, based on reservations, attributes and categories, and/or other parameters.

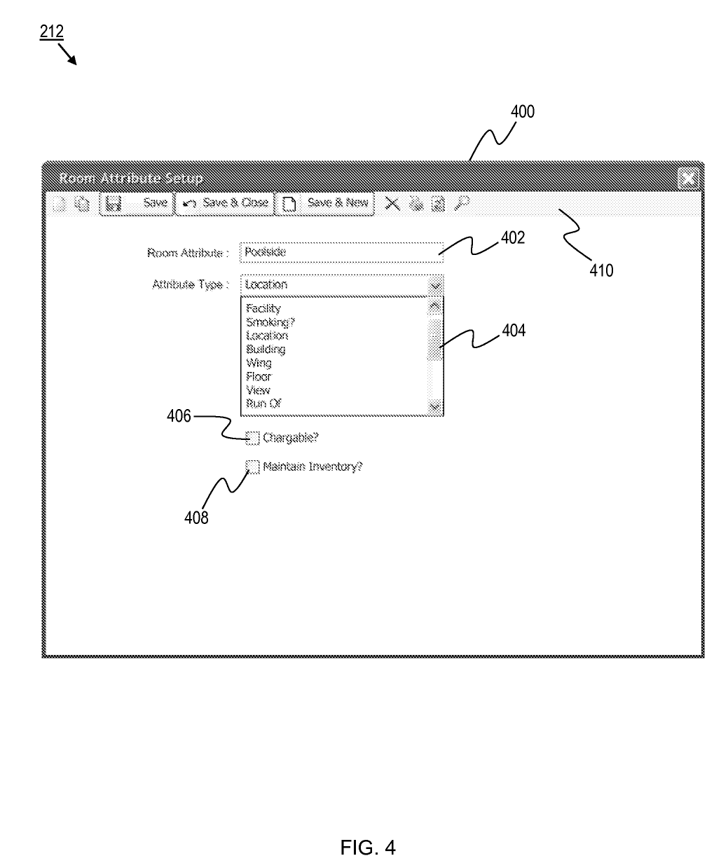

The user interface 212 includes many different display screens for implementing and/or utilizing the allocation engine. As used herein, “display screen” can encompass, for example, text boxes, check boxes, dialog boxes, windows, menus, tool bars, buttons, pop-up screens, and other combinations and variations thereof. Various exemplary display screens of the user interface 212 are shown in FIGS. 4-10, in the context of a property management system for allocating rooms in a hotel.

In the property management system 200, traditional “room types” are replaced with a combination of inventoried category items and/or attributes (see FIGS. 4-7). Hence, for purposes of allocating the rooms, each room is viewed as a collection of category items.

FIG. 4 shows a display screen 400 of the user interface 212, according to one exemplary embodiment. The display screen 400 allows the user 208 (or other authorized user, such as an administrator of the property management system 200) to define or otherwise setup one or more attributes for a room. The display screen 400 includes a text entry box 402 for naming a room attribute to be defined. The display screen 400 also includes a pull-down menu 404 for selecting from a list of pre-defined attribute types or categories. Exemplary attribute types include facility, smoking preference, location, building, wing, floor, view, and run of. The display screen 400 further includes check boxes 406 and 408 for indicating whether the defined attribute is to be a chargeable attribute and whether an inventory summary is maintained for this defined attribute, respectively.

A chargeable attribute is one in which there is some cost to a guest for that attribute. An example of this is a refrigerator attribute where some rooms have refrigerators and others do not. This would be considered inventoried (i.e., maintained in inventory) in that the inventory model would always know how many of the rooms possessing that attribute (i.e., having refrigerators as a permanent part of their description) are reserved at any given point in time. There are some room attributes that may be inventoried but not chargeable (e.g., a “near elevator” attribute). There are typically no attributes that are chargeable but not inventoried. Certain chargeable items can be added to the reservation ad hoc, but would not need to be inventoriable items such as “parking.”

The display screen 400 also includes a toolbar 410 that provides numerous standard functions, which facilitate setup of the attributes for the rooms. The standard functions include, for example, saving the room attribute setup, deleting the room attribute setup, printing the room attribute setup, refreshing the room attribute setup, and searching the room attribute setup.

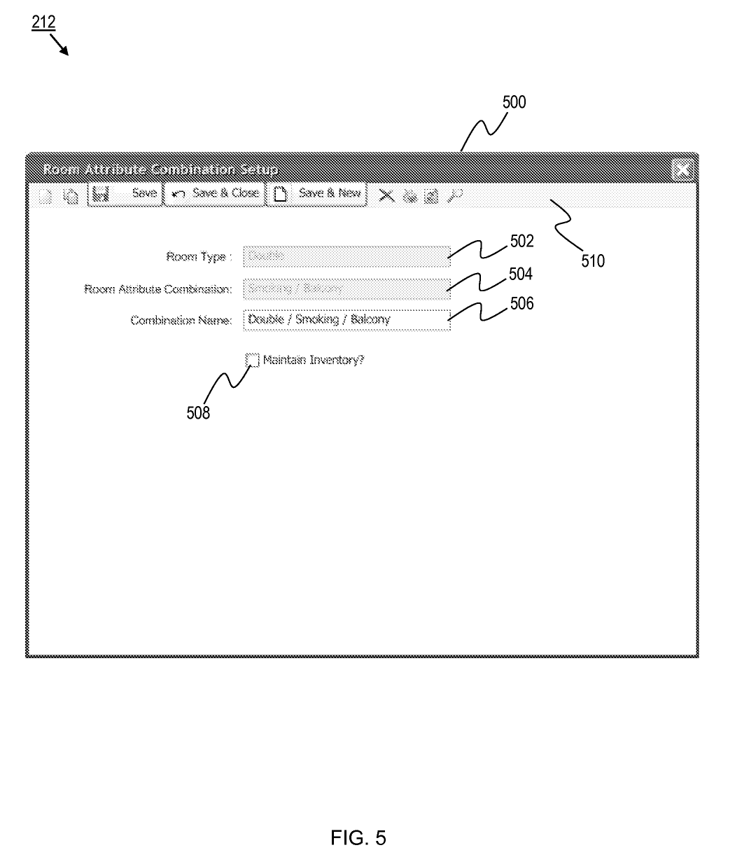

FIG. 5 shows a display screen 500 of the user interface 212, according to one exemplary embodiment. The display screen 500 allows a user (e.g., the user 208) to define or otherwise setup an attribute combination. An attribute combination is a combination of two or more discrete attributes, associated with a room type. An attribute combination is a combination of two or more discrete attributes, associated with a specific room. These combinations of discrete attributes are maintained and managed in the inventory model.

Flexibility of the property management system 200 is increased by allowing the user to work with discrete attributes and/or combinations of attributes. For example, attribute combinations can be used to define the more traditional combined categories (e.g., room type, bedding configuration, and smoking preference), while maintaining the attribute-level management of the inventory. As another example, attribute combinations can be used to divide the inventory of rooms into several general categories, while the use of additional attributes can be used to further differentiate the rooms among and/or across the general categories.

The display screen 500 includes three text boxes 502, 504, and 506. The text box 502 is for inputting a room type for the attribute combination. In the example shown in FIG. 5, the input room type is “Double.” The text box 504 is for inputting a room attribute combination, i.e., a combination of two or more discrete attributes. In the example shown in FIG. 5, the room attribute combination is “Smoking/Balcony.” The text box 506 is for naming the attribute combination. In the example shown in FIG. 5, the attribute combination is named “Double/Smoking/Balcony.”

The display screen 500 further includes check box 508 for indicating whether an inventory summary is maintained for the defined attribute combination. If an attribute to be used in an attribute combination is not inventoried (i.e., using check box 408 in display screen 400), then any attribute combination including the non-inventoried attribute cannot be setup and/or will not be inventoried.

In general, maintaining inventory is the practice of applying management rules for controlling over- or under-sell of any given attribute or combination of attributes. Since different attributes can be assigned to rooms in any combination, keeping this inventory in line (e.g., balanced) requires complex and quick analysis during each transaction. The property management system 200 performs these functions (i.e., keeps the inventory in balance) under the following conditions: (i) varying arrival and departure dates by guests; (ii) varying numbers of rooms per guest; (iii) varying combinations of rooms (each with their own attributes) that are assembled to create suites; (iv) all future dates as discrete entities; (v) multiple hotels within one database; (vi) management-directed quantities to over or undersell any attribute; and (vii) specific rooms that are not assigned at the time of reservation, with instead only a collection of attributes being committed to the guest.

The display screen 500 also includes a toolbar 510 that provides numerous standard functions, which facilitate setup of the attribute combinations. The standard functions include, for example, saving the room attribute combination setup, deleting the room attribute combination setup, printing the room attribute combination setup, refreshing the room attribute combination setup, and searching the displayed room attribute combination setup.

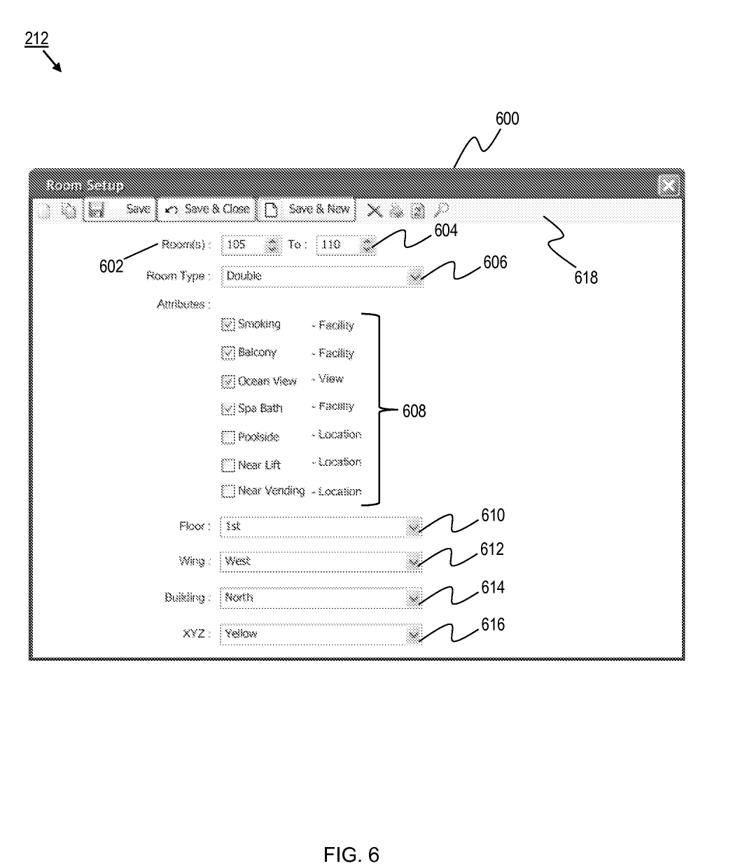

FIG. 6 shows a display screen 600 of the user interface 212, according to one exemplary embodiment. The display screen 600 allows a user (e.g., the user 208) to assign predefined attributes to a room or block of rooms. The display screen 600 includes a pair of text boxes 602, 604 for specifying a range of rooms for which the selected attributes will be assigned. In particular, the text box 602 is used to indicate a starting room number and the text box 604 is used to indicate an ending room number, wherein the starting room number to the ending room number are the range of rooms for which the attributes will be assigned. If the starting room number and the ending room number are the same, then the selected attributes will be assigned only to that room number. In the example shown in FIG. 6, the attributes are being set for rooms 105 to 110.

The display screen 600 includes a pull-down menu 606 for selecting a room type for the room or range of rooms. In the example shown in FIG. 6, the currently selected room type is “Double.”

The display screen further includes a collection of check boxes 608 that represent various attributes which have been defined for the inventory of rooms. The displayed attributes each include one of the aforementioned check boxes 608, an attribute name, and an attribute type or category. In the example shown in FIG. 6, the attributes “Smoking,” “Balcony,” and “Spa Bath” are all facility type attributes, i.e., they all relate directly to a room in some manner. For example, “Smoking” indicates that smoking is allowed in the room; “Balcony” indicates that the room includes a balcony; and “Spa Bath” indicates that the room includes a spa bath. In FIG. 6, the attribute “Ocean View” is a view type attribute, i.e., it relates to a view from a room. For example, “Ocean View” indicates that an ocean can be seen clearly from the room. In FIG. 6, the attributes “Poolside,” “Near Lift,” and “Near Vending” are all location type attributes, i.e., they all relate to a location of a room relative to another object, service, location, or the like. For example, “Poolside” indicates that the room is adjacent to a swimming pool on the property; “Near Lift” indicates that the room is in close proximity to a lift; and “Near Vending” indicates that the room is in close proximity to one or more vending machines. Using the check boxes 608, the user can assign one or more of the attributes to the specified room or range of rooms (e.g., rooms 105 to 110).

The display screen 600 includes pull-down menus 610, 612, 614, and 616 for selecting additional attributes of and/or specifying additional information on the room or range of rooms. The pull-down menu 610 is used to specify a floor on which a room is located. In the example shown in FIG. 6, the selected rooms are on the 1st floor. The pull-down menu 612 is used to specify a wing in which a room is located. In the example shown in FIG. 6, the selected rooms are in the West wing. The pull-down menu 614 is used to specify a building in which a room is located. In the example shown in FIG. 6, the selected rooms are in the North building.

The pull-down menu 616 is used to indicate that the hotel management can specify anything else as an inventory item attribute. The previous attribute categories are merely examples. The property management system 200 allows a user (e.g., the user 208) to specify any room attributes they want, with the XYZ label for the pull-down menu 616 being a reminder or indicator that all of the attribute types and attribute values, including their labels, are configurable. The user could call the attribute category corresponding to the pull-down menu 616 anything, since the property management system 200 gives no importance to the labels themselves.

The display screen 600 also includes a toolbar 618 that provides numerous standard functions, which facilitate setup of the rooms. The standard functions include, for example, saving the room setup, deleting the room setup, printing the room setup, refreshing the room setup, and searching the displayed room setup.

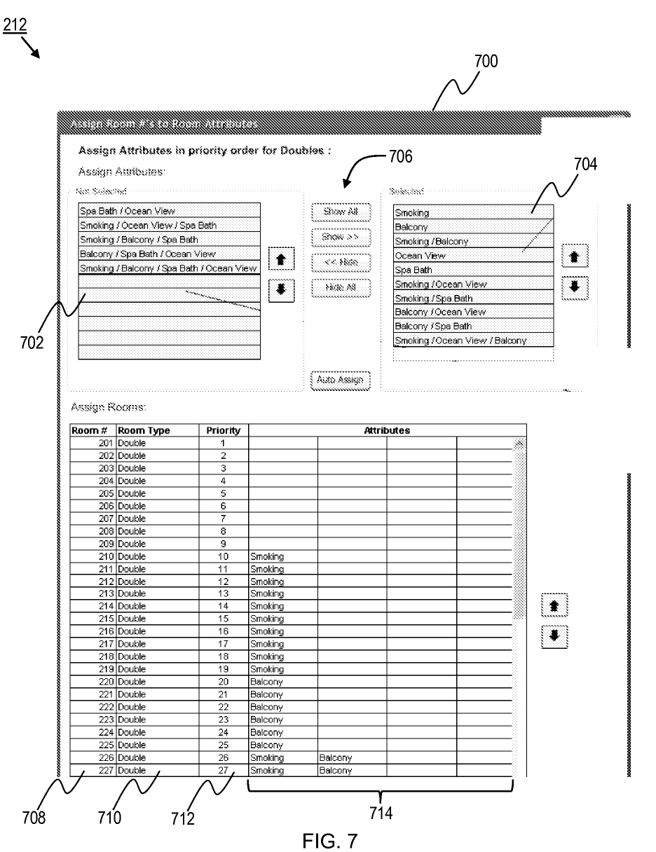

FIG. 7 shows a display screen 700 of the user interface 212, according to one exemplary embodiment. The display screen 700 allows a user (e.g., the user 208) to assign priorities among attributes and/or attribute combinations, in this case, for a selected room type. The display screen 700 includes a list 702 of non-selected (i.e., hidden) attributes and attribute combinations and a list 704 of selected (i.e., shown) attributes and attribute combinations, wherein the lists 702 and 704 together include all of the defined attributes and attribute combinations, or some applicable subset thereof. The display screen 700 includes tools 706 (e.g., buttons) that allow the user to move an attribute or attribute combination from one of the lists 702, 704 to the other. By ordering the attributes and/or attribute combinations in the list 704, priorities are assigned among the rooms of the selected room type.

In the example shown in FIG. 7, twenty-seven rooms 708 (i.e., rooms 201 to 227) of the selected room type 710 (here, “double”) are each assigned a priority 712 based on the attributes or combination of attributes 714 for the respective rooms. In the property management system 200, the priorities allow the user to, for example, designate that all things being equal one specific room should appear higher on a selection list or be automatically assigned in an auto-assign scenario than another room. This is useful when it is time to assign a specific room to a guest.

With the various attributes defined and associated with the appropriate rooms, the property management system 200 allows the user 208 to interact with the user interface 212 to manage the inventory of rooms based on their attributes. For example, the property management system 200 allows the user 208 to generate various inventory-related reports based on one or more selected attributes and/or attribute combinations. For example, the user 208 can generate a room availability report to see the availability of rooms matching attribute criteria specified by the user 208. As another example, the user 208 can generate a room rate report for rooms matching attribute criteria specified by the user 208. Based on this system, one of ordinary skill in the art will appreciate that numerous other reports and other presentations of information could be provided by the property management system 200.

By representing rooms as inventoried category items and attributes, the property management system 200 allows a user (e.g., the user 208) to specify a limited number of category items to complete a reservation process. Many rooms, however, may include other category items in addition to the specified category items, wherein these other category items are often perceived and priced differently. Accordingly, the allocation engine of the property management system 200 assists the user in determining and adding any additional inventory category items to facilitate room assignment. Additionally, overbooking logic implementing an overbooking process, as described below, may allow certain category items to be overbooked. To address such overbooking, the allocation engine of the property management system 200 facilitates the systematic upgrading of certain reservations in order to assign the room numbers appropriately at the hotel on the day of arrival.

As used herein, “room allocation,” i.e., room (category) allocation, refers to allocating the right category combination for a reservation based on reserved room categories. Room allocation is performed at a pre-arrival stage of the reservation. As used herein, “room assignment” or “reservation fulfillment” refers to assignment of a room number to a reservation based on reserved room categories or allocated room categories.

The functionality of the allocation engine of the property management system 200 includes, for example, matching or exceeding the room inventory category items reserved and paid for; applying a guest value concept into the process of room (i.e., category) allocation; systematically and consistently applying a reasoned criteria for room category allocation and room number assignment; and insuring room category allocation does not adversely impact the overall availability of room category items.

To support this functionality of the allocation engine, the inventoried categories and category items have a predefined hierarchy at every property. In one exemplary embodiment, the hierarchy is implemented as a matrix that identifies an attribute and the indicated level upgrades. For example, a “garden view” attribute would have a level 1 upgrade to “bay view” and a level two upgrade to “bay front.”

This hierarchy is used to determine the sequence in which the rooms will be allocated. The hierarchy is created initially at the time of set up, and then updated every time the category items change or when the inventory gets updated. The user interface 212 of the property management software 202 promotes interaction between the user 208 and the property management system 200 to allow the user 208 (representing the property) to create and save the hierarchy of categories and category items. In one exemplary embodiment, the predefined hierarchy is based, at least in part, on priorities assigned to the various inventory categories and attributes (see FIG. 7).

The room allocation process of the allocation engine can be invoked on the day of arrival and/or for future dates. Additionally, the room allocation process can be invoked for a selected segment of bookings or for all bookings Walk-ins need to be addressed so same day reservations will reflect allocated upgrades.

A user (e.g., the user 208) of the allocation engine can accept or reject the results of the room allocation process. Additionally, an allocated upgrade can be subsequently downgraded manually by the user.

Overbook, retention and “run of” are inter-related concepts, all of which are designed to give hotels greater flexibility for and control over the selling of their room inventory. As used herein, “overbook” means a number or percentage of commitments which has the effect of increasing the threshold at which point overbooking logic is engaged. As used herein, “retention” means a number or percentage of commitments which has the effect of decreasing the threshold at which point overbooking logic is engaged. As used herein, “overbooking logic” refers to a method or process by which a warning of overbooking is relayed to the user and the logic by which the user can or cannot proceed with the booking.

As used herein, “run of” refers to using generic or unspecified categories and attributes in the booking and inventory processes, as opposed to using all categories and specific attributes in each. This allows greater flexibility in room assignment, as the unstated or “generic” aspects of the booking allow for a greater variety of choices in the assignment process. In the property management system 200, the “run of” aspect of the allocation engine can be utilized across the defined room attributes. Accordingly, specific attributes or attribute combinations will need to be limited or restricted if the use of them for “run of” management is not desired.

When a reservation is booked, if normal availability for the desired booking would not allow the booking to occur, the overbooking logic is engaged. The user can then proceed to complete the overbooking and the action will be logged. As noted above, an overbook or retention number simply has the effect of altering the threshold at which the overbooking logic is engaged. Overbooking counts shift the engagement from occurring at zero availability to below zero; i.e., the net effect is to raise a housecount for the inventory combination in question. A retention count shifts the engagement from occurring at zero availability to something above zero; i.e., the net effect is to lower the housecount for the inventory combination in question. For example, if a hotel has 200 King rooms and an overbooking number of 10 is applied, the overbooking logic will not engage until an attempt is made to book the 211th King room. As another example, if the hotel has 200 King rooms and a retention number of 10 is applied, the overbooking logic will engage when an attempt is made to book the 191st King room.

As used herein, “housecount” generally refers to a count of a property's inventory records, less any non-inventoried records, for a given date. In one exemplary embodiment, there are three types of designations that allow a user (e.g., the user 208) of the property management system 200 to readily alter a room's availability: “Out of Order (OOO),” “Off the Market (OTM),” and “Temporary Hold (TMP).” The OOO and OTM designations are used to allow the user to make rooms unavailable to sell, wherein these designations would remove the rooms from the housecount. TMP reservations are used to prevent a room from being assigned but otherwise do not affect the inventory, such that this designation does not remove the room from the housecount. The user has the ability to select what types they would like to use, if they should reduce the house count, and what the default cleaning status is when the room is returned.

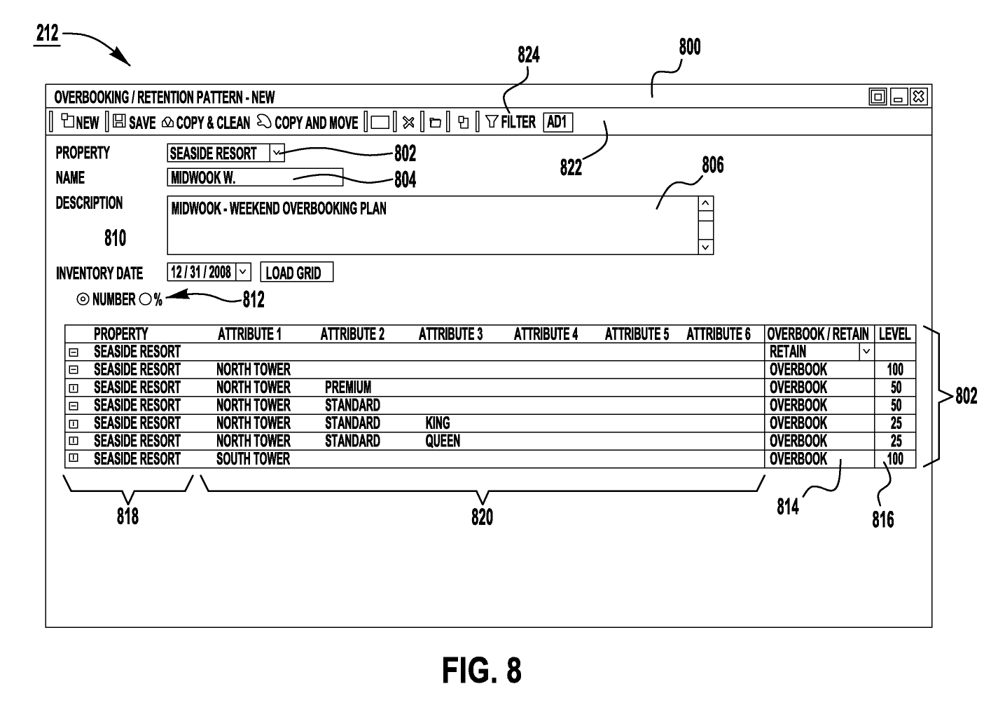

FIG. 8 shows a display screen 800 of the user interface 212, according to one exemplary embodiment. The display screen 800 allows a user (e.g., the user 208) to create and/or modify an overbook/retention pattern 802 for a property. The display screen 800 includes a pull-down menu 804 for selecting the property for which the overbook/retention pattern 802 applies. The display screen 800 also includes text boxes 806 and 808 for naming and describing, respectively, the overbook/retention pattern 802. The display screen 800 includes tools (e.g., pull-down menu 810) for specifying an inventory date for the overbook/retention pattern 802, and tools (e.g., radio buttons 812) for indicating whether the overbook/retention pattern 802 is presented with numerical values or percentages.

In the example shown in FIG. 8, the overbook/retention pattern 802 includes a series of rows defining the pattern. Each row of the overbook/retention pattern 802 represents an overbook or retention value or level, input via a pull-down menu 814 and a text box 816. Each row of the overbook/retention pattern 802 further indicates the applicable property 818 and room category or type defined by the inclusion and/or exclusion of one or more attributes 820.

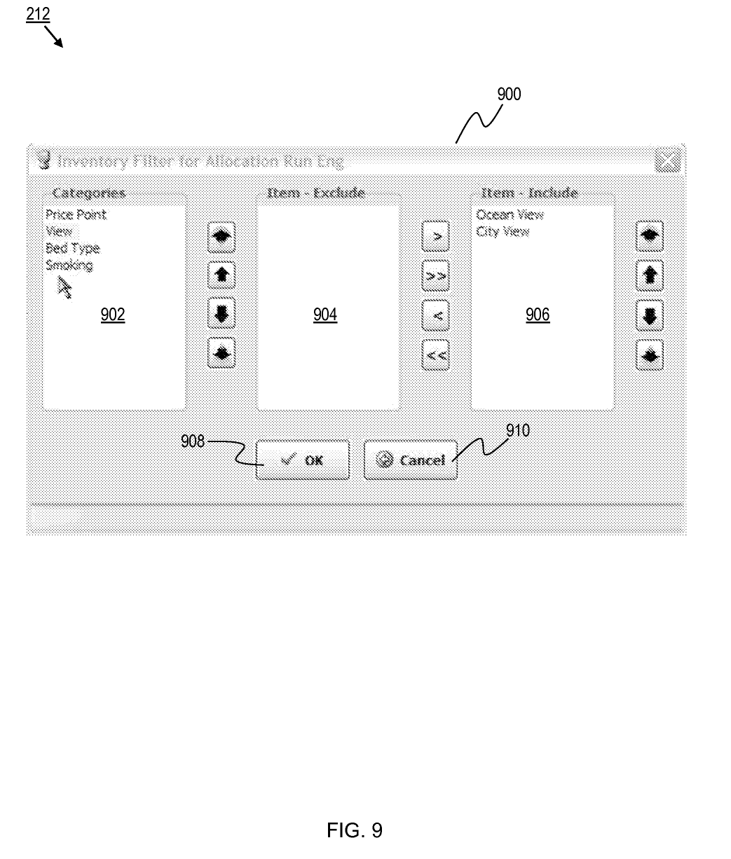

The display screen 800 also includes a toolbar 822 that provides numerous standard functions, which facilitate creation and/or modification of the overbook/retention pattern 802. The standard functions include, for example, saving the overbook/retention pattern 802 and deleting the overbook/retention pattern 802. The toolbar 822 also includes an icon 824 for launching an inventory filter (see FIG. 9).

FIG. 9 shows a display screen 900 of the user interface 212, according to one exemplary embodiment. The display screen 900 represents an inventory filter that allows a user (e.g., the user 208), for example, to include and/or exclude inventory categories and attributes from creation of the overbook/retention pattern 802. In order for the user to exclude a category completely, the user will need to hide all of the attributes for the given category. The inventory filter also allows the user to re-sequence categories and attributes, which enables the overbook/retention pattern 802 to be set in alternate ways.

In the example shown in FIG. 9, the inventory filter includes a list 902 of available or applicable inventory categories and/or attributes, a list 904 of inventory categories and/or attributes to be excluded (i.e., filtered out), and a list 906 of inventory categories and/or attributes to be included (i.e., not filtered out). Only attributes associated with an inventory category will be displayed in the list 902. By interacting with the display screen 900, the user can populate the lists 904 and 906 with categories and/or attributes from list 902 to perform the desired filtering. Thereafter, the user can click an “OK” button 908 to accept the selected filtering or click a “Cancel” button 910 to reject the selected filtering, and then return to the display screen 800.

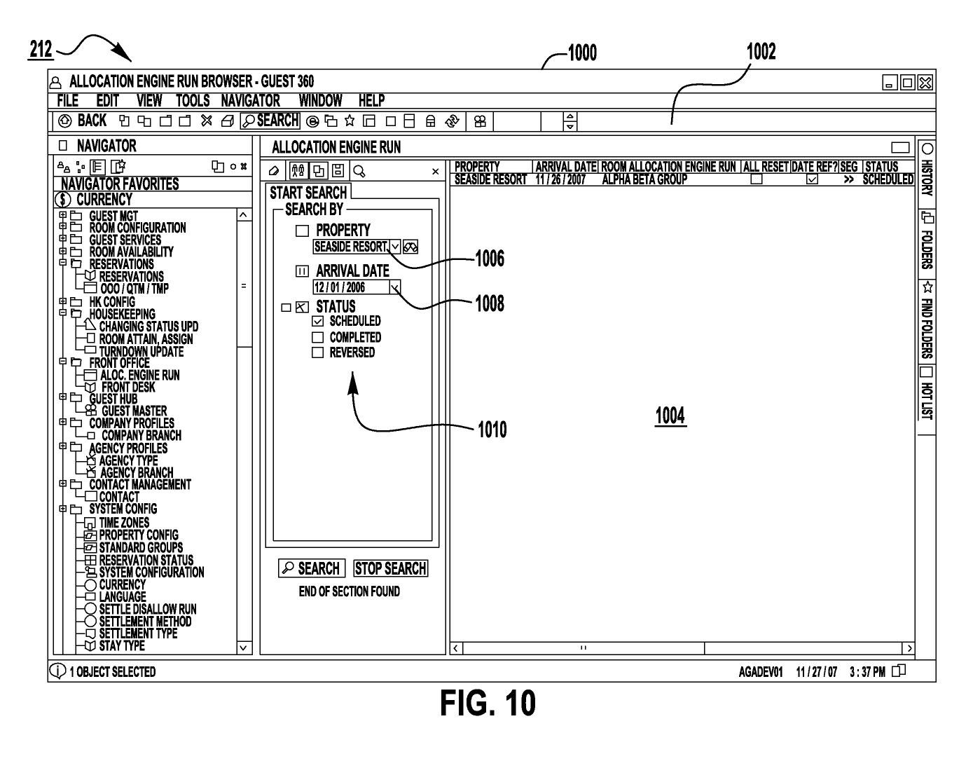

FIG. 10 shows a display screen 1000 of the user interface 212, according to one exemplary embodiment. The display screen 1000 allows a user (e.g., the user 208) to initiate an allocation engine (e.g., to browse scheduled allocation runs), within the property management system 200. When the allocation engine is first accessed, an explorer bar 1002 of the display screen 1000 defaults to an open operation. The default view displays scheduled allocation runs 1004 for the current day. The display screen 1000 includes pull-down menus 1006 and 1008, which allow the user to specify a property and an arrival date, respectively, for browsing the scheduled allocation runs. Both the property and arrival date are required fields. The arrival date can be any date that is greater than or equal to current property date. The default property value is a primary property associated with the user. The default arrival date is the current property date.

Additionally, check boxes 1010 allow the user to further qualify the status of the allocation runs to browse. In the example shown in FIG. 10, the check boxes 1010 correspond to scheduled, completed, and reversed allocation runs. A reversed allocation run is one in which the allocations recommended by the allocation engine for a completed allocation run are reset. The status check boxes 1010 act as a filter, such that when any of the checkboxes 1010 are checked, the returned records will be limited to the checked statuses. If none of the checkboxes 1010 are checked, all records will be returned for the property and arrival date specified by the user. Accordingly, the status is an optional field.

Other display screens (not shown) of the user interface 212 allow the user, for example, to schedule allocation runs, initiate allocation runs, interact with the results of allocation runs, search existing reservations, and the like. In one exemplary embodiment, these other display screens are similar in appearance to display screen 1010. In one exemplary embodiment, the functionality of these other display screens is integrated with or otherwise provided by display screen 1010. In this manner, the property management system 200 provides a robust and efficient allocation engine for effectively allocating items of inventory (e.g., rooms) based on a current state of commitments for the inventory, wherein the items of inventory are defined by categories and attributes associated therewith.

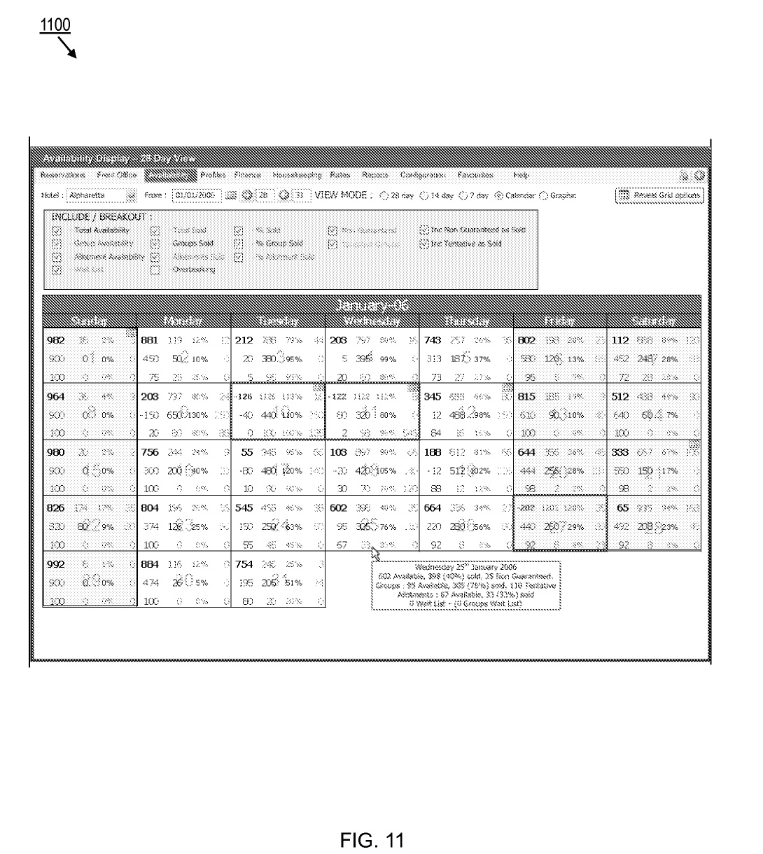

In one exemplary embodiment, the property management system 200 maintains two distinct views (e.g., sets of records) relating to bookings For example, the first view reflects what rooms have actually been sold by the hotel, such as guaranteed reservations, while the second view reflects what rooms have been given by the hotel, such as upgrades from the allocation engine. This second view is maintained for allocations purposes and does not affect the first view (i.e., the two views are not reconciled) until and unless an allocated room becomes a sold room, such as when a party actually checks into the room. Accordingly, this second view allows a user (e.g., the user 208) to clearly determine the number and nature of allocations that have been made by the allocation engine or otherwise within the property management system 200. These distinct views also support the creation of complex sold and/or allocated displays, reports, or the like, such as the availability calendar 1100 shown in FIG. 11.

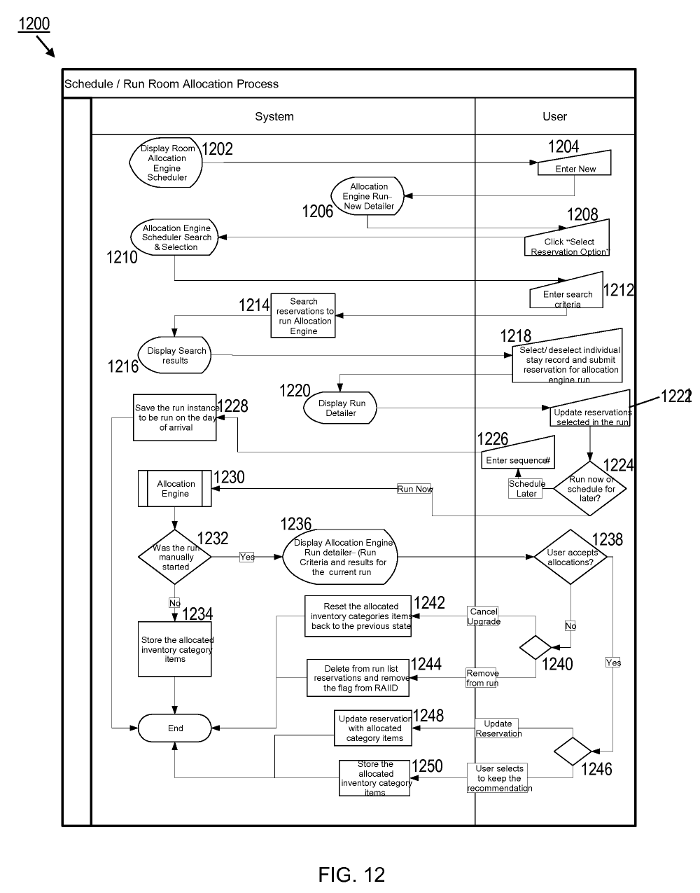

FIG. 12 shows a flowchart illustrating a room (category) allocation method 1200, according to one exemplary embodiment. The rectangular elements denote “processing blocks” and represent computer software instructions or groups of instructions. The diamond shaped elements denote “decision blocks” and represent computer software instructions or groups of instructions which affect the execution of the computer software instructions represented by the processing blocks. Alternatively, the processing and decision blocks represent steps performed by functionally equivalent circuits such as a digital signal processor circuit or an application-specific integrated circuit (ASIC). The flow diagram does not depict syntax of any particular programming language. Rather, the flow diagram illustrates the functional information one skilled in the art may use to fabricate circuits or to generate computer software to perform the processing of the system. It should be noted that many routine program elements, such as initialization of loops and variables and the use of temporary variables are not shown.

The method 1200 includes scheduling and running a new room allocation process. In an initial step 1202, a property management system (e.g., the property management system 200) displays a room allocation engine scheduler to a user (e.g., the user 208). The user selects to schedule a new room allocation at 1204, which causes the system to display an allocation engine run detailer interface at 1206. From the run detailer interface, the user clicks on a “select reservation” option at 1208, which causes the system to display an allocation engine scheduler search and selection interface at 1210. From the scheduler search and selection interface, the user enters search criteria at 1212. The system uses this search criteria to search reservation records for the allocation engine at 1214, after which the search results are displayed by the system to the user in step 1216. The user interacts with the displayed search results to select and/or deselect reservation records from among the search results at 1218, wherein the selected/deselected records are for use in running the room allocation process. The system then displays the run detailer interface at 1220, after which the user can further update the reservation records selected for the run at 1222.

Next, in step 1224, the user selects whether the room allocation process is to be scheduled for later or run now. If the user elects to schedule the room allocation process for another time, the user inputs a sequence number at 1226. Scheduled room allocation runs (i.e., runs having a sequence number) are carried out on the day of arrival in the specified sequence. Thereafter, the scheduled room allocation run instance is saved at 1228 for eventual running on the day of arrival, and the method 1200 ends. Conversely, if the user elects, in step 1224, to run the room allocation process now, the system launches an allocation engine for carrying out the room allocation process at 1230.

After initiating the allocation engine, in step 1230, the system determines at 1232 whether the room allocation run was manually started. If the system determines that the room allocation was not manually started, the results of the room allocation process (i.e., the allocated inventory category items) are stored at 1234, and the method 1200 ends.

Conversely, if the system determines that the room allocation run was manually started, the system displays an allocation engine run detailer interface at 1236, wherein the allocation engine run detailer interface includes the run criteria and the results of the current room allocation run. In step 1238, the user interacts with the run detailer interface to accept or reject the allocations from the current room allocation run.

If the user rejects the allocations, the user can cancel upgrades or remove reservations from the run, in step 1240. In one exemplary embodiment, an upgrade flag is added when the allocated categories are higher than the reserved categories. If the user elects to cancel upgrades, the user can select reservations marked as upgrades such that the system removes the allocated categories from the reservation, which in effect resets the allocated inventory category items back to their previous state at 1242, and the method 1200 ends. Conversely, if the user elects to remove reservations from the run, the user can select reservations for removal and the system will remove the allocated categories from the selected reservations (as well as removing the flag for the run instance) at 1244, and the method 1200 ends.

If the user accepts the allocations, the user can update reservations or keep the recommended allocations, in step 1246. If the user elects to update reservations, the user can specify reservations and the system will update those reservations with allocated category items at 1248, and the method 1200 ends. If the user elects to keep the recommended allocations, the system stores the allocated inventory category items at 1250, and the method 1200 ends.

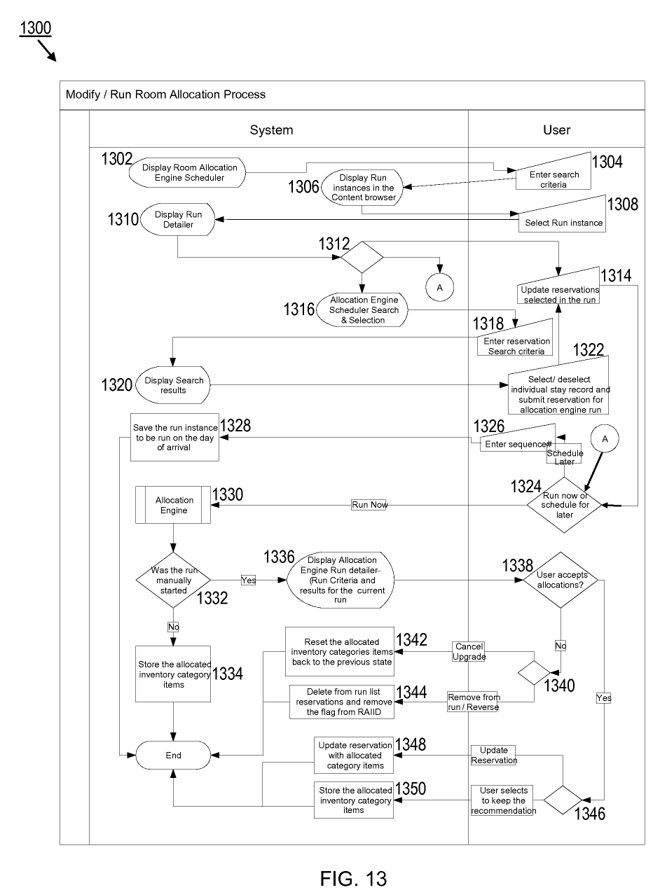

FIG. 13 shows a flowchart illustrating a room (category) allocation method 1300, according to one exemplary embodiment. The method 1300 includes updating or otherwise changing a scheduled room allocation process, and then running the updated room allocation process. In an initial step 1302, a property management system (e.g., the property management system 200) displays a room allocation engine scheduler to a user (e.g., the user 208). The user enters search criteria at 1304 for searching previously defined and saved room allocation run instances. Based on this search criteria, the system displays the corresponding run instances at 1306 from which the user selects a specific run instance at 1308. The system then displays the run detailer interface at 1310 providing the user with the options at 1312 of updating the reservation records in the specific run instance, searching the reservation records for the specific run instance, or running the specific run instance.

If the user elects at 1312 to update the reservation records in the selected run instance, the user can update the reservation records for the run instance at 1314. If the user elects at 1312 to search the reservation records, the system displays an allocation engine scheduler search and selection interface at 1316. From the scheduler search and selection interface, the user enters search criteria at 1318. The system uses this search criteria to search reservation records for the specific run instance, after which the search results are displayed by the system to the user in step 1320. The user interacts with the displayed search results to select and/or deselect reservation records from among the search results at 1322, wherein the selected/deselected records are used for updating the reservation records for the specific run instance at 1314.

If the user elects at 1312 to run the selected run instance, the user selects, in step 1324, whether the run instance is to be scheduled for later or run now. If the user elects to schedule the run instance for another time, the user inputs a sequence number at 1326. Scheduled room allocation runs (i.e., runs having a sequence number) are carried out on the day of arrival in the specified sequence. Thereafter, the scheduled run instance is saved at 1328 for eventual running on the day of arrival, and the method 1300 ends. Conversely, if the user elects, in step 1324, to run the run instance now, the system launches an allocation engine for carrying out the run instance at 1330.

After initiating the allocation engine, in step 1330, the system determines at 1332 whether the run instance was manually started. If the system determines that the run instance was not manually started, the results of the room allocation process (i.e., the allocated inventory category items) are stored at 1334, and the method 1300 ends.

Conversely, if the system determines that the run instance was manually started, the system displays an allocation engine run detailer interface at 1336, wherein the allocation engine run detailer interface includes the run criteria and the results of the current room allocation run. In step 1338, the user interacts with the run detailer interface to accept or reject the allocations from the current room allocation run.

If the user rejects the allocations, the user can cancel upgrades or remove reservations from the run, in step 1340. In one exemplary embodiment, an upgrade flag is added when the allocated categories are higher than the reserved categories. If the user elects to cancel upgrades, the user can select reservations marked as upgrades such that the system removes the allocated categories from the reservation, which in effect resets the allocated inventory category items back to their previous state at 1342, and the method 1300 ends. Conversely, if the user elects to remove reservations from the run, the user can select reservations for removal and the system will remove the allocated categories from the selected reservations (as well as removing the flag for the run instance) at 1344, and the method 1300 ends.

If the user accepts the allocations, the user can update reservations or keep the recommended allocations, in step 1346. If the user elects to update reservations, the user can specify reservations and the system will update those reservations with allocated category items at 1348, and the method 1300 ends. If the user elects to keep the recommended allocations, the system stores the allocated inventory category items at 1350, and the method 1300 ends.

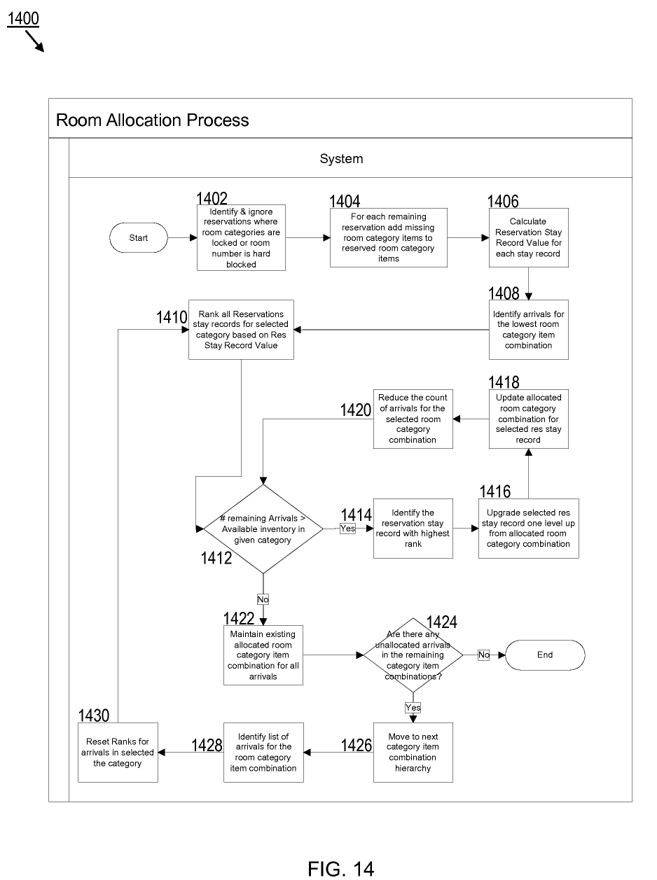

FIG. 14 shows a flowchart illustrating a room (category) allocation process 1400 carried out by an allocation engine (e.g., the property management software 202) of a property management system (e.g., the property management system 200). In one exemplary embodiment, the room allocation process 1400 corresponds to step 1230 in FIG. 12. In one exemplary embodiment, the room allocation process 1400 corresponds to step 1330 in FIG. 13.

In carrying out the room allocation process 1400 using the current reservation records or an applicable subset thereof, the allocation engine identifies and ignores those reservation records where the room categories are locked or the room number is hard blocked, in step 1402. For each of the remaining (i.e., non-ignored) reservation records, the allocation engine adds any missing room category items to the reserved room category items at 1404. Next, the allocation engine calculates a reservation record value for each reservation record at 1406, and identifies arrivals for the lowest level (e.g., priority) room category item combination at 1408. Calculation of the reservation record values can be based on subjective and/or objective criteria. In step 1410, the allocation engine ranks the reservation records for the current selected category based on the reservation record values. The allocation engine then determines at 1412 if the number of remaining arrivals is greater than the available inventory in the current category.

If the allocation engine determines that the number of remaining arrivals is greater than the available inventory in the current category, the allocation engine identifies the reservation record having the highest rank at 1414 and upgrades this reservation record one level from the allocated room category combination at 1416. The allocation engine updates the allocated room category combination for the reservation record at 1418 to reflect the upgrade. The allocation engine then reduces the number of remaining arrivals (i.e., the arrivals count) for the current category by one at 1420, with the room allocation process then returning to step 1412.

Conversely, if the allocation engine determines that the number of remaining arrivals is not greater than the available inventory in the current category, the allocation engine maintains the existing allocated room category item combination for all of the arrivals at 1422. In step 1424, the allocation engine determines if there are any unallocated arrivals in the remaining category item combinations.

If the allocation engine determines that there are not any such unallocated arrivals, the process 1400 ends. Conversely, if the allocation engine determines that there are such unallocated arrivals remaining, the allocation engine selects the next category item combination in the hierarchy at 1426. In step 1428, the allocation engine identifies the arrivals for the current category item combination. Next, the allocation engine resets the ranks of the reservation records for this category item combination at 1432, with the room allocation process then returning to step 1410.

As disclosed herein, the general inventive concepts include property management systems and methods that are highly flexible in allocating inventory items in a predefined, hierarchical fashion, thereby balancing current reservations and accounting for overbook and/or retention criteria. The general concepts also include inventory allocation processes that can be readily scheduled to run with little or no user involvement. The general inventive concepts further include property management systems and methods that can readily track upgraded reservations, separate from original or otherwise confirmed reservations. Further still, the general inventive concepts include property management systems and methods that can flexibly allocate inventory items based on discrete attributes associated with the inventory items.

The systems and methods of the present invention can be implemented on a variety of platforms including, for example, networked computer systems and stand-alone computer systems. Additionally, the logic and databases shown and described herein preferably reside in or on a computer readable medium such as, for example, a Read-Only Memory (ROM), Random-Access Memory (RAM), programmable read-only memory (PROM), electrically programmable read-only memory (EPROM), electrically erasable programmable read-only memory (EEPROM), magnetic disk or tape, and optically readable mediums including CD-ROM and DVD-ROM. Still further, the processes and logic described herein can be merged into one large process flow or divided into many sub-process flows. The order in which the process flows herein have been described is not critical and can be rearranged while still accomplishing the same results. Indeed, the process flows described herein may be rearranged, consolidated, and/or re-organized in their implementation as warranted or desired.

The above description of specific embodiments has been given by way of example. From the disclosure given, those skilled in the art will not only understand the general inventive concepts and their attendant advantages, but will also find apparent various changes and modifications to the structures and methods disclosed. For example, although the above exemplary embodiments reference managing rooms in a hotel, the general inventive concepts can be extended to other similar inventory situations, such as managing cabins on a cruise ship. It is sought, therefore, to cover all such changes and modifications as fall within the spirit and scope of the general inventive concept, as defined by the appended claims and equivalents thereof.

1. A property management system for allocating rooms of at least one property, said property management system comprising:
a computer; and
at least one data storage device,
wherein said computer is in communication with said data storage device,
wherein said data storage device stores said data,
wherein said data includes computer readable instructions for processing by said computer,
wherein said data includes a plurality of attributes,
wherein said data includes a plurality of priorities,
wherein each of said rooms is associated with at least one of said attributes and one of said priorities,
wherein said attributes are parsed for each available room to determine all available rooms that have attributes that match any attributes specified in a room request, and
wherein one of said available rooms matching the specified attributes is allocated in response to said room request based on said priorities of said available rooms.

2. The system of claim 1, wherein at least one of said attributes is a chargeable attribute.

3. The system of claim 2, wherein a rate associated with a room is determined based on all of its chargeable attributes.

4. The system of claim 1, wherein said attributes comprise at least one of room quality attributes, bed size attributes, and smoking preference attributes.

5. The system of claim 1, wherein said attributes include a plurality of first attributes and a plurality of second attributes,
wherein said first attributes are used to divide said rooms into a plurality of general categories, and
wherein said second attributes are used to further differentiate said rooms amongst said general categories.

6. The system of claim 5, wherein said first attributes are facility type attributes, and
wherein said second attributes are non-facility type attributes.

7. The system of claim 6, wherein said first attributes comprise at least one of room quality attributes, bed size attributes, and smoking preference attributes.

8. The system of claim 6, wherein said second attributes are view type attributes.

9. The system of claim 6, wherein said second attributes are location type attributes.

10. The system of claim 1, wherein at least one of said attributes is a combination of two or more discrete attributes.

11. The system of claim 1, wherein if more than one available room is able to satisfy said room request, a room associated with a highest priority is allocated for said room request.

12. A property management system for allocating rooms of at least one property, said property management system comprising:
a computer; and
at least one data storage device,
wherein said computer is in communication with said data storage device,
wherein said data storage device stores said data,
wherein said data includes computer readable instructions for processing by said computer,
wherein said data includes a plurality of attributes,
wherein said data includes a plurality of priorities,
wherein said data includes an upgrade hierarchy that indicates whether a second attribute of said attributes is designated an upgrade for a first attribute of said attributes,
wherein each of said rooms is associated with at least one of said attributes and one of said priorities,
wherein said attributes are parsed for each available room to determine all available rooms that have attributes that match any attributes specified in a room request,
wherein one of said available rooms is allocated in response to said room request based on said priorities of said available rooms, and
wherein if a first available room having said first attribute and allocated to said room request is no longer available during fulfillment of said room request, said computer uses said upgrade hierarchy to automatically allocate another available room as a second available room having the same attributes as said first available room but with said second attribute instead of said first attribute.

13. The system of claim 12, wherein said computer further uses said priorities to automatically allocate said second available room during fulfillment of said room request.

14. The system of claim 12, wherein said upgrade hierarchy is associated with only one property.

15. The system of claim 12, wherein said data includes a first set of records containing information on any sold rooms and a second set of records containing information on any allocated rooms.

16. A property management method for allocating rooms of at least one property, said property management method comprising:
defining a plurality of attributes,
defining a plurality of priorities,
associating each room with at least one of said attributes and one of said priorities,
parsing said attributes of each available room to determine all available rooms that have attributes that match any attributes specified in a room request, and
allocating one of said available rooms in response to said room request based on said priorities of said available rooms.

17. A property management method for allocating rooms of at least one property, said property management method comprising:
defining a plurality of attributes,
defining an upgrade hierarchy that indicates whether a second attribute of said attributes is designated an upgrade for a first attribute of said attributes,
defining a plurality of priorities,
associating each room with at least one of said attributes and one of said priorities,
parsing said attributes of each available room to determine all available rooms that have attributes that match any attributes specified in a room request,
allocating one of said available rooms in response to said room request based on said priorities of said available rooms, and
if a first available room having said first attribute and allocated to said room request is no longer available during fulfillment of said room request, using said upgrade hierarchy to automatically allocate any other available room as a second available room having the same attributes as said first available room but with said second attribute instead of said first attribute.

18. The method of claim 17, further comprising: using said priorities to automatically allocate said second available room during fulfillment of said room request.
